(19) United States
(12) Patent Application Publication
(10) Pub. No.: US 2019/0010877 A1
(43) Pub. Date: Jan. 10, 2019

(54) SPRING RETURN THROTTLE ACTUATOR, METHOD OF CONTROL THEREOF AND THROTTLE ASSEMBLY

(71) Applicant: Scania CV AB, Södertälje (SE)

(72) Inventors: Fredrik STRÅÅT, Stockholm (SE); Sebastian ZAMANI, Stockholm (SE)

(73) Assignee: Scania CV AB, Södertälje (SE)

(21) Appl. No.: 16/066,624

(22) PCT Filed: Dec. 12, 2016
(86) PCT No.: PCT/SE2016/051246

§ 371 Date: Jun. 27, 2018

(30) Foreign Application Priority Data
Jan. 5, 2016 (SE) 1650011-8

(51) Int. Cl. F02D 11/10; F02D 9/10; G01D 5/14; F16K 31/04; F16K 1/22

(52) U.S. Cl. CPC F02D 11/106; F02D 9/1065; F16K 1/221; F16K 31/042; G01D 5/145

(57) ABSTRACT

A spring return throttle actuator including: an electric, plural-coil DC motor having an output shaft, a throttle return spring, a gear transmission connected to the output shaft, a control unit adapted to control power supply to the DC motor, wherein the spring return throttle actuator has a movement range between closed throttle and opened throttle. The control unit is arranged to short-circuit at least two DC motor coils in order to create a DC motor return resist torque, and the control unit includes a movement monitoring circuit being arranged to monitor actuator movement forced by the throttle return spring and resisted by the DC motor return resist torque. The invention also relates to a method and a throttle assembly.

### CROSS-REFERENCE TO RELATED APPLICATION(S)

This application is a National Stage Application (filed under 35 § U.S.C. 371) of PCT/SE2016/051246, filed Dec. 12, 2016 of the same title, which, in turn claims priority to Swedish Application No. 1650011-8 filed Jan. 5, 2016 of the same title; the contents of each of which are hereby incorporated by reference.

### FIELD OF THE INVENTION

The invention relates to a spring return throttle actuator including: an electric, plural-coil, DC motor having an output shaft, a throttle return spring, a gear transmission connected to the output shaft, a control unit adapted to control power supply to the DC motor, wherein the actuator has a movement range between closed throttle and opened throttle. The invention also relates to a method for control thereof and a throttle assembly.

### BACKGROUND OF THE INVENTION

Throttle assemblies are employed to control gas streams in respect of vehicle engines. The actuator DC motor is typically supplied with an electric current to switch from a normally open to a closed throttle position or from a normally closed to an open throttle position.

It could be mentioned that in respect of for example an air inlet throttle valve, the throttle is normally open whereas in an EGR valve the throttle is normally closed.

As a rule, the return spring tend to move the throttle to a determined “normal” position which will guarantee operation also in the event that the DC motor is without current. It is thereby an aim to maintain the required exhaust gas values etc.

In a background art throttle assembly, for reaching intermediate positions between closed throttle and fully opened throttle, the DC motor is supplied with current to create a dynamic electromotive force which, by virtue of the control unit, balances the spring force to obtain a desired stationary throttle position between closed throttle and fully open throttle.

It is previously known that there are occasionally problems with throttles for example because of a mechanical deficiencies or some sort of obstruction preventing unrestricted movement of the throttle. This might depend on the formation of ice or the accumulation of dirt around the seat of the throttle or in throttle shaft bearings, or a defective spring which for example has been damaged and obtained unwanted properties.

The throttle can hereby be impossible or difficult to move properly and at proper speed over the whole or part of its movement range which is detrimental to the operation of the vehicle. Also relatively small restrictions and influences on throttle movements may impair engine control.

### SUMMARY OF THE INVENTION

It is an aim of the present invention to provide measures to be able to address the problems of the background art so as to be able to at least reduce these problems.

This aims are obtained in a respect of a throttle actuator according to the above in that the control unit is arranged to short-circuit at least two of the coils of the DC motor in order to create a DC motor return resist torque (counteracting electromotive force EMF), and that the control unit includes a movement monitoring circuit being arranged to monitor actuator movement forced by the spring and resisted by the DC motor return resist torque.

With the term “DC motor return resist torque” is meant that a counteracting electromotive force is generated which resists return torque generated by the spring.

The invention makes it possible to monitor the condition of the return spring in an advantageous manner. Basically the return spring is dimensioned such that generated spring torque over the whole movement range of the actuator exceeds said DC motor return resist torque for the chosen number of short-circuit coils.

Furthermore, the actuator movement is possible to monitor in the complete range, in an intermediate range or part ranges, between fully opened and fully closed.

According to the invention, in a system where a plurality of elements co-act it is important to be able to analyze each single component such that the problem can be isolated and the failing component or existing problem be attended to.

In order to monitor the condition of the return spring, the spring is typically maximally stretched and strained by maximally actuating the throttle against the spring force, whereupon the system is made currentless and a selected number of coils are short-circuited. By thereupon monitoring the movement pattern and compare it as regards movement speed etc. with a desired stored reference movement pattern, it is possible to establish the condition of the spring. This also means that if the spring is unable to move the throttle with the chosen number of coils short-circuited, the spring is probably defective.

The invention can also be used to determine the mechanical spring constant for a perfectly operating component. It is thereupon possible to adapt possible control systems to this information in order to optimize control performance.

Having knowledge of a throttle actuation problem that exists and in which part of the movement range of the throttle there are, in fact, deviations, it is also possible, according to the invention, to adapt engine control to the prevailing throttle actuation conditions. Hereby vehicle control can be performed with increased usability and reduced error value.

According to the invention, two or more coils of the DC motor are short-circuited, thereby creating a determined resistance (electro motive force) for a spring to act against. This electro motive force can be more or less continuous or even at the same level through the entire movement range.

Furthermore, the control system can be taught where the throttle meets resistance, in which part of the range the throttle meets resistance and therefore moves unpredictably, and to determine whether the throttle has become stuck or moves with restricted speed and, in that case, in which position it has got stuck or moves with restricted speed.

In these cases it is not necessary to take notice of elapsed time, since it is possible to perform digital monitoring over the entire throttle movement range.

With the aid of the inherent feedback from the DC motor and/or from movement detectors such as Hall effect sensors or the like the movement pattern can be established since throttle movement hereby is easily detected.

Furthermore, the invention makes it possible to determine that the spring is jamming which could depend on it being broken so that it has obtained unwanted characteristics.

For example, according to the invention, elapsed time to open and close the throttle can be measured and compared to stored, prescribed values. Also, even movement speed per time unit and/or other suitable movement parameters of the throttle in question can be measured and compared to stored, prescribed movement curves reflecting movement speed per time unit and other respective suitable parameters of a throttle operating as prescribed.

The term “movement pattern” is basically intended to be interpreted broadly and can in its simplest form reflect time consumed for a complete opening or closing movement. In a more complex analysis, time consumed for a part of a complete opening or closing movement can be analyzed. In a more sophisticated analysis, the movement speed or acceleration over the complete movement range or part or parts thereof is compared to an exemplary curve reflecting a throttle moving as prescribed.

It is also possible to store different movement pattern curves for actuators having respective differently damaged or otherwise defective return springs giving an opportunity to easily analyze the nature of a defect.

The inventive actuator basically does not require any particular hardware components for the purpose of monitoring. Instead the properties and characteristics of the DC motor can basically be exploited. As an example, information from the DC motor can be obtained by measuring motor voltage which easily gives momentary rotational speed.

When coils of the DC motor are short-circuited, a current flows through the stator which leads to the creation of a counter-force even when a very small movement is induced to the rotor. This is in particular the case for brushless DC-motors and permanent magnet synchronic motors.

Suitably the DC motor includes three coils and two or all three coils may be subject to short-circuiting.

The control unit preferably includes a bridge circuit having one branch connected to each one of the coils. This circuitry makes the actuator easily controlled in an economic and logical manner. This advantage is even more enhanced when each branch includes a transistor switch connected to each one of the coils.

At least one movement sensor is preferably positioned to detect DC motor rotor movements in order to guarantee stability and maintained settings and adjustability. In particular it is advantageous when a plurality of Hall sensors is positioned to detect DC motor rotor movements, the Hall sensors of said plurality being distributed around the rotor to increase measurement accuracy. The sensors can also be positioned such that they detect the position of the throttle itself or an element of the transmission, since the position of the motor can be derived therefrom.

Controlling pulses from the Hall sensors easily gives the possibility to obtain rotational position and rotational speed.

It is preferred that the control unit includes an evaluation circuit arranged to evaluate output signals from the movement monitoring circuit for deviations from stored values. Evaluation can result in the problem or problems being diagnosed, in turn making it possible to address the true problem or problems to produce a solution.

Preferably said stored values relate to various exemplary problem situations whereby comparing the obtained signal values with stored example signals values makes it possible to specify or at least assume the existing or at least probable problem.

In an inventive method of controlling a spring return throttle actuator, wherein the actuator includes: an electric, plural-coil DC motor having an output shaft, a throttle return spring, a gear transmission connected to the output shaft, a control unit adapted to control power supply to the DC motor, wherein the actuator has a movement range between closed throttle and fully opened throttle, wherein at least two DC motor coils are short-circuited by the control unit in order to create a DC motor return resist torque, and wherein the movement forced by the spring and resisted by the return resist force is monitored over the whole movement range of the actuator.

Advantages corresponding to the above are gained in respect of the inventive method.

The DC motor advantageously includes three coils and two or all three coils are preferably short-circuited.

The coils are preferably supplied with power from each one branch of a bridge circuit being included in the control unit.

Advantageously each branch is switched through separate transistor switches.

DC motor rotor movements are preferably detected by at least one movement sensor and more preferred by a plurality of Hall sensors being rotationally distributed to increase measurement accuracy.

Preferably, the control unit issues a condition message to the user in the cases where it is appropriate, for example when service is required.

Output signals from the movement monitoring circuit are preferably evaluated by an evaluation circuit of the control unit for deviations from a stored values.

It is highly preferred, in order to enhance analysis of the spring that result obtained from movement forced by the spring being monitored with at least two DC motor coils being short-circuited is supplemented with movement forced by the spring being monitored without any one of the DC motor coils being short-circuited in order to create DC motor return resist torques of different levels. Hereby the movement pattern/return speed will differ with the different resist torques allowing more detailed analysis and possibilities of discovering also relatively small defects.

A typical sequence to monitor the condition of the return spring could for example include the following steps:
the spring is stretched and strained by maximally actuating the throttle against the spring force.
the system is made currentless and no coils are short-circuited.
the movement pattern/return speed is monitored.
the spring is stretched and strained by maximally actuating the throttle against the spring force.
the system is made currentless and two coils are short-circuited.
the movement pattern/return speed is monitored
the spring is stretched and strained by maximally actuating the throttle against the spring force.
the system is made currentless and three coils are short-circuited.
the movement pattern/return speed is monitored.
the results of the three captured movements indicated above (or only two thereof) are compared with desired stored reference movement pattern/return speed.

The invention also relates to a throttle assembly including a throttle and a throttle actuator wherein the throttle actuator is according to what is stated above.

Further features of and advantages of the invention will be explained below at the background of embodiments.

### BRIEF DESCRIPTION OF DRAWINGS

The invention will now be described in greater detail by way of embodiments and with reference to the annexed drawings, wherein:

FIG. 1 illustrates a throttle assembly including a spring return throttle actuator according to the invention,

FIG. 2 shows a control circuit for the inventive throttle actuator, and

FIG. 3 shows a simplified flow chart over an inventive method.

### DETAILED DESCRIPTION OF THE INVENTION

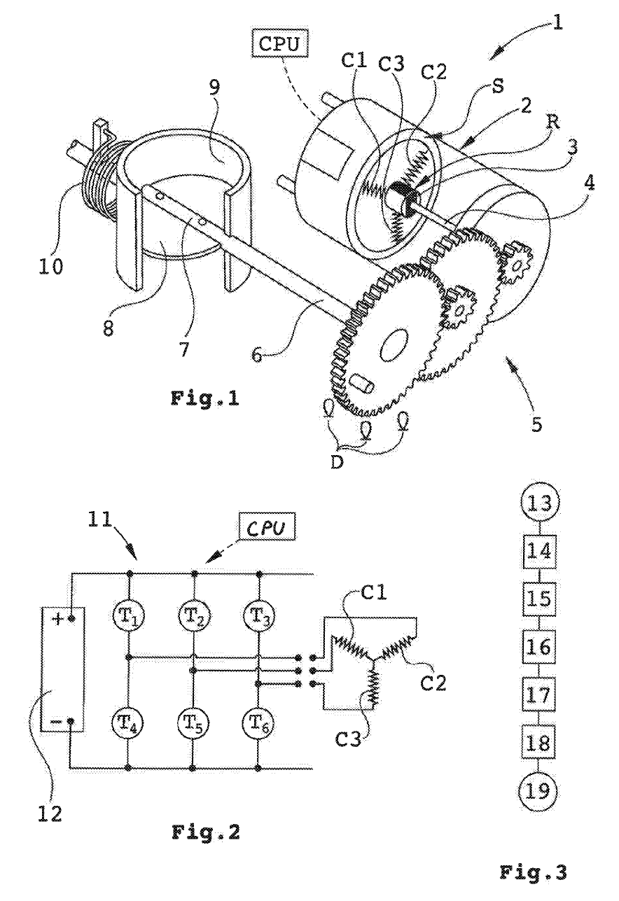

FIG. 1, shows a throttle assembly whereof a spring return throttle actuator is generally depicted with reference number 1. The actuator 1 includes a DC motor 2 having three coils C1, C2 and C3 in its stator S. The rotor R is as usual provided with a permanent rotor magnet 3 and an output shaft 4.

A gear transmission 5 is connected to the output shaft 4 and an outgoing shaft 6 from the gear transmission 5 is coupled with its distal end to a throttle shaft 7 of a throttle 8. The actuator has a movement range between closed throttle and fully opened throttle.

The throttle 8 is arranged in a channel 9 to control a gas stream flowing through the channel 9.

A throttle return spring 10 is positioned around the outgoing shaft 6 and functions to provide a spring torque urging the outgoing shaft 6 to rotate towards a “normal” position of the throttle 8 which may be fully open or fully closed depending on the nature of the throttle as explained above.

A control unit CPU is connected to the DC motor and is adapted to control supply of power to the DC motor and thereby to control the throttle position. Movement sensors, preferably Hall effect sensors, are indicated with D.

FIG. 2 illustrates a bridge circuit 11 positioned between a 24 Volts current source 12 for the supply of power to the three coils C1, C2 and C3 of the DC motor 3.

The bridge circuit includes a set of transistor switches T₁-T₆ that are made conductive—non conductive to controllably power supply the DC motor 3.

In order to short-circuit all coils C1, C2 and C3, the transistor switches T₁-T₆ are made conductive and electric voltage is cut off. It is possible to make variations of the duration of conductivity of the transistor switches in order to apply force of different magnitudes by varying and by controlling transistor switches. It is also possible to short-circuit only two of the coils, whereby obviously a reduced rotation resist torque will arise compared to when all three coils are short-circuited.

It is possible to receive information from the DC motor and associated cables about its operation. If the motor is rotated, the rotational speed is directly proportional to the voltage. It is also possible to measure voltage which momentarily results in knowledge of rotational speed. For detection of rotational position of the rotor of the motor, a plurality of detectors is preferably being used. This gives information about throttle position.

The detectors are suitably stationary and for example co-operating with a ring being rotationally associated with the rotor or with one of the shafts, said ring having a great number of evenly distributed marks or holes. Monitoring the durations between pulses from three distributed mark or hole detectors results in information of position and rotational speed. There is also a possibility to detect rotor acceleration if required for some reason.

In the simplified flow chart in FIG. 3, an exemplary method sequence related to the invention is briefly illustrated.

13 indicates start of sequence.

14 indicates initiating DC motor to position throttle in desired position where the return spring is strained and stretched and verifying that throttle has reached the desired position.

15 indicates cutting current to DC motor and initiating circuit to short-circuit DC motor coils to obtain a resist torque.

16 indicates monitoring throttle or rotor movements effected by the return spring with short-circuited coils.

17 indicates evaluating monitored throttle movement pattern in relation to a stored exemplary movement curve.

18 indicates amending and adapting engine control values to established prevailing throttle actuation conditions.

19 indicates issuing a condition message to the user and ending of sequence.

The sequence may be supplemented with additional steps and is repeated as required.

The invention can be modified within the scope of the annexed claims. For example, the control circuitry can be laid out differently as can be the DC motor, for instance, the number of coils of the DC motor can be other than three.

The feature “closed throttle” is intended to include a case with totally blocked opening as well as a case with a certain minimum opening that might exist. With the feature “opened throttle” is intended the maximum opening achievable for the throttle in question.

Different kinds of sensors may be employed and they can be positioned in various places in association with the throttle assembly, for example close to the throttle itself.

1. A spring return throttle actuator having a movement range between a closed throttle and an opened throttle, said actuator comprising:
an electric, plural-coil DC motor having an output shaft;
a throttle return spring;
a gear transmission connected to the output shaft; and
a control unit adapted to control power supply to the DC motor,
wherein the control unit is configured to short-circuit at least two DC motor coils of said DC motor to create a DC motor return resist torque, and
wherein the control unit comprises a movement monitoring circuit configured to monitor actuator movement forced by the throttle return spring and resisted by the DC motor return resist torque.

2. An actuator according to claim 1, wherein the DC motor includes three coils.

3. An actuator according to claim 1, wherein the control unit comprises a circuit comprising a plurality of branches, with one branch connected to each one of the coils.

4. An actuator according to claim 3, wherein each branch of said circuit comprises a transistor switch connected to each one of the coils.

5. An actuator according to claim 1, wherein at least one movement sensor is positioned to detect DC motor rotor movements.

6. An actuator according to claim 5, wherein a plurality of Hall sensors are positioned to detect DC motor rotor movements, said plurality of Hall sensors being rotationally distributed to increase measurement accuracy.

7. An actuator according to claim 1, wherein the control unit comprises an evaluation circuit arranged to evaluate output signals from the movement monitoring circuit for deviations from stored values.

8. A method of controlling a spring return throttle actuator, wherein the actuator has a movement range between a closed throttle and a fully opened throttle, said actuator comprising: an electric, plural-coil, DC motor having an output shaft; a throttle return spring; a gear transmission connected to the output shaft; and a control unit adapted to control power supply to the DC motor, said method comprising:
short-circuiting at least two DC motor coils of said DC motor to create a DC motor return resist torque; and
monitoring movement forced by the spring and resisted by the return resist torque over a whole movement range of the actuator.

9. A method according to claim 8, wherein the DC motor comprises three coils, wherein short-circuiting comprises short-circuiting two or three coils of said DC motor.

10. A method according to claim 8, further comprising supplying power to the coils of said DC motor with power from a circuit comprising a plurality of branches, with one branch connected to each one of the coils.

11. A method according to claim 10, wherein each branch of said circuit is switched through separate transistor switches.

12. A method according to claim 8, further comprising monitoring movement of the rotor of said DC motor using at least one movement sensor.

13. A method according to claim 12, wherein monitoring movement of the rotor of said DC motor are performed using a plurality of Hall sensors distributed around the rotor to increase measurement accuracy.

14. A method according to claim 12, further comprising evaluating output signals from the movement sensor using an evaluation circuit to determine deviations from stored values.

15. A method according to claim 8, supplementing a result obtained from movement forced by the spring being monitored with at least two DC motor coils being short-circuited with movement forced by the spring being monitored without DC motor coils being short-circuited in order to create DC motor return resist torques of different levels.

16. A throttle assembly including a throttle and a spring return throttle actuator having a movement range between a closed throttle and an opened throttle, said actuator comprising:
an electric, plural-coil DC motor having an output shaft;
a throttle return spring;
a gear transmission connected to the output shaft; and
a control unit adapted to control power supply to the DC motor, wherein the control unit is configured to short-circuit at least two DC motor coils of the DC motor to create a DC motor return resist torque, and
wherein the control unit comprises a movement monitoring circuit configured to monitor actuator movement forced by the throttle return spring and resisted by the DC motor return resist torque.

17. A throttle according to claim 16, wherein the control unit comprises a circuit comprising a plurality of branches, with one branch connected to each one of the coils.

18. A throttle according to claim 17, wherein each branch of said circuit comprises a transistor switch connected to each one of the coils.

19. A throttle according to claim 16, wherein at least one movement sensor is positioned to detect DC motor rotor movements.

20. A throttle according to claim 16, wherein the control unit comprises an evaluation circuit arranged to evaluate output signals from the movement monitoring circuit for deviations from stored values.
